(19) United States
(12) Patent Application Publication
(10) Pub. No.: US 2026/0011794 A1
(43) Pub. Date: Jan. 8, 2026

(54) BATTERY BLAST PREVENTION SYSTEM FOR REMOVABLE AND FIXED BATTERIES

(71) Applicant: Pulkit Ahuja, New Delhi (IN)

(72) Inventor: Pulkit Ahuja, New Delhi (IN)

(21) Appl. No.: 18/992,609

(22) PCT Filed: Jul. 7, 2023
(86) PCT No.: PCT/IN2023/050665

§ 371 Date: Jan. 9, 2025

(30) Foreign Application Priority Data
Jul. 11, 2022 (IN) 202211039815

(51) Int. Cl. H01M 10/42; A42B 3/04; H01M 50/202; H01M 50/247; H01M 50/342; H01M 50/383

(52) U.S. Cl. CPC H01M 10/4257; H01M 50/202; H01M 50/247; H01M 50/3425; H01M 50/383; A42B 3/0406; H01M 2010/4271

(57) ABSTRACT

The present invention is for a system which proactively prevents any explosion or combustion of a single battery or a pack of single cell or multi cell batteries. The present invention discloses an independent cell or capacitor (fireproof and fire protected) (FIG. 2 (1)) and sensors (which can monitor temperature and size variation of the battery) (FIG. 2 (2)), which are fixed inside a casing. This casing further consists a three-sided piezo electric container (FIG. 2 (4)), which contains a highly pressurized powdered or gaseous fire retardant. The present invention further protects the remaining components of the device or the automobile, which could otherwise get damaged because of the explosion, deformation or combustion of the batteries.

### FIELD OF THE INVENTION

The subject matter herein relates to an independent system which provides a mechanism for preventing the battery from explosion proactively irrespective of battery chemistry, battery type, battery shape or size.

### BACKGROUND AND PRIOR ART

A battery can be defined as an electrochemical device, consisting of one or more electrochemical cells, which can be charged with an electric current and discharged whenever required. Batteries are widely employed in order to power electric devices such as mobile phones, remotes, flashlights, electric cars, industrial helmets, etc.

Batteries are broadly classified into two categories, namely primary batteries and secondary batteries. Primary batteries can only be charged once. When these batteries are completely discharged, they become useless and must be discarded. The most common reason why primary batteries cannot be recharged is that the electrochemical reaction that takes place inside of them is irreversible in nature. It is important to note that primary batteries are also referred to as use-and-throw batteries.

On the other hand, secondary batteries are the batteries than can be charged and reused for many charging-discharging cycles. The electrochemical reactions that take place inside these batteries are usually reversible in nature. Therefore, secondary batteries are also known as rechargeable batteries. When discharging, the reactants combine to form products, resulting in the flow of electricity. When charging, the flow of electrons into the battery facilitates the reverse reaction, in which the products react to form the reactants.

Some of the examples of batteries are Lead-Acid battery, Nickel-Cadmium (NiCad) battery and Lithium-Ion battery. Lead-Acid battery, are highly desirable for use in motor vehicles and automobiles in order to provide the high current required to start the engine. Whereas NiCad battery can most commonly be found in certain toys and small electronic devices such as TV remotes. Lithium-ion batteries are known to have many applications in powering electric vehicles, industrial helmets and is also known to be used extensively in the aerospace industry. These are also widely used in mobile phones and portable computers (laptops and tablets).

These batteries when used are at risk of malfunctioning and explosion, which can cause damage to the device for which it is used or any other part of such device or to the person using such device. This malfunctioning and explosion may be because of the short circuit, mechanical abuse, thermal abuse, overcharging, etc. To deal with such problems relating to batteries, there have been developed several kinds of Battery Management Systems.

Battery Management System (BMS) is a technology dedicated to the oversight of a battery pack, which is an assembly of battery cells. These batteries, especially lithium batteries can be used only in specified conditions, and therefore battery management system is necessary in order to monitor battery state and ensure safety of operation. Some of the examples of different types of battery management systems are:
a) High Voltage battery management systems for electric vehicles.
b) Charge Balancing and Temperature Control battery management system

There has been now growing reliance on lithium-ion batteries and therefore, ensuring safety throughout the period of devices, including electric vehicles, smart helmets etc., using these batteries is expected and is crucial. Failure of these batteries would result in increase of expensive warranty liabilities, recalls, and in worst case scenarios, catastrophic events would lead to increased risk or loss of life. Some of the conditions that lead to battery failure includes fast charge, low-temperature charge, overcharge, over-discharge, internal and external shorts, and overtemperature. These issues are sometimes triggered by malfunctioning battery management systems (BMSs), thermal management system etc. In fact, these methods may work effectively for single cells, but its implementation in multi-cell configuration is challenging.

It is now being noticed that BMS, which is an important accessory of Li-ion battery, is more prone to failure. Some of the causes, which results in BMS failure are illustrated below:
a) BMS system does not work after the system is powered, the reasons include abnormal power supply, short circuit or break in the wiring harness, and no voltage output.
b) BMS cannot communicate with Electronic Control Unit (ECU), when the BMU (master control module) is not working and the CAN signal line is disconnected.
c) When there is unstable communication between BMS and ECU
d) When BMS internal communication is unstable due to lose communication line plug, CAN alignment is not standardized etc.
e) The battery temperature difference is too large or when the battery temperature is too high or too low, when there is loose cooling fan plug, cooling fan failure, temperature probe damage.
f) When the power cell system is deformed or leaking, an insulation failure will occur, that leads non-detection of BMS and consequently leading to electric shock or other failures.

Nowadays, batteries are also being used in smart helmets and other protective headgear. Any failure in the battery, fitted inside the helmet would lead to physical injuries or may even cause loss of life.

These problems in the prior art have led to death of thousands of people because of the failure or malfunctioning of battery and battery management system. Lithium-Ion batteries have been found to be ‘number one’ cause of fire related deaths in certain areas like Vancouver in 2022, There are prior arts, which allows to extinguish fire after the blast or explosion of the battery, however, the same are redundant as the affect of such blast or explosion could not be prevented by the same technology and would eventually lead to fire and other damages to the devices, automobiles or persons using them.

Hence. there is a need to develop a system that will be helpful in preventing the blast or explosion or even deformation of the batteries.

### AIMS AND OBJECTIVES

The primary objective of the invention is to develop a universal system which will prevent any kind of battery or a group of batteries from causing damage to the device or automobile it is being used in due to fire, explosion or deformation of the battery. The system would in turn eliminate risk to the person using these devices or automobiles by ensuring that the battery does not damage or destroy the device or automobile due to fire even if the battery/batteries malfunction or the BMS fails, irrespective of the battery type and battery chemistry.

### SUMMARY OF THE INVENTION

The present invention is for a system which proactively prevents any explosion or combustion of a single battery or a pack of single cell or multi cell batteries. The present invention discloses a independent cell or capacitor (fireproof and fire protected) (FIG. 1 (1)) and sensors (which can monitor temperature and size variation of the battery) (FIG. 1 (2)), which are fixed inside a casing. This casing further consists a three-sided piezo electric container (FIG. 1 (4)), which contains a highly pressurized powdered or gaseous fire retardant. The fire retardant used can include carbon dioxide, powdered sodium bicarbonate, or any other such fire retardants appropriate for electronic and electrical fires.

There is also a tear-able film (FIG. 1 (5)), forming the fourth side of the three-sided piezoelectric container. The film which can tear under two-sided mechanical force is facing the battery in such a way that only the film separates the piezo electric container from the battery being monitored.

When there is rise in temperature or any change in temperature of the battery beyond the preconfigured benchmark limit set on the temperature sensor, or when there is any deformation or leaking from the battery noticed by the shape monitoring sensor, the sensors attached with casing trips the fuse (FIG. 1 (3)), connecting the piezoelectric container and the standalone cell. Thereafter, the electric charge from the cell is received by the piezoelectric device.

This transfer of charge to the piezoelectric device changes the dimensions of the piezoelectric material in an inverse piezoelectric effect along the axis of the tear-able film, causing rupture of the film material due to generation of mechanical strain in response to the electric charge. This rupture of the tear-able film material forming the fourth side of the piezoelectric container further results in the release of pressurized fire retardant from within the container into the battery area thereby engulfing the entire battery or group of batteries proactively and completely with a fire retardant eliminating any scope of combustion. This puts an end to any change in the battery that was sensed/detected by the sensors due to an increase in temperature or deformation of battery/batteries, preventing the explosion or any other kind of damage to the device or automobile.

The present invention further protects the remaining components of the device or the automobile, which could otherwise get damaged because of the explosion, deformation or combustion of the batteries.

### BRIEF DESCRIPTION OF THE DRAWINGS

FIG. 1: Battery Blast Prevention System (Without Battery)

FIG. 2: Battery Blast Prevention System along with the Battery

FIG. 3: Multi-Battery Blast Prevention System

FIG. 4: Battery Blast Prevention System installed inside the Smart Helmet

### DETAILED DESCRIPTION OF THE INVENTION

The present invention relates to the development of a system which helps in proactively preventing any explosion or combustion of a single battery or a pack of single cell or multi cell batteries. Battery management system employed earlier had many disadvantages, which has been explained in the preceding paragraphs. The present invention deals with such issues and overcomes them with a mechanism, which ensures that not only the body and circuitry of the device is protected but it also protects the user from getting physical injuries. The present invention further helps in protecting the remaining components of the device or the automobile, which could otherwise get damaged because of the explosion, deformation or combustion of the batteries, thereby ensuring that in case of a battery or battery management system (BMS) malfunction, only the Battery Blast Protection System and the malfunctioning batteries need to be replaced while leaving the remainder of the device or the automobile intact.

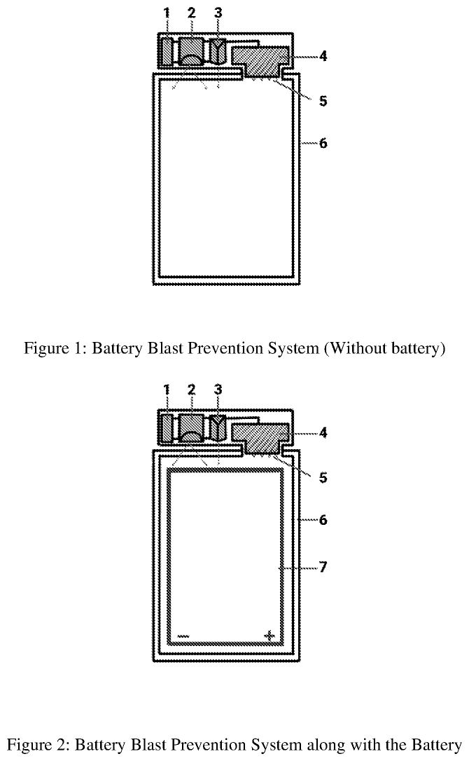

The present invention discloses a standalone button cell or capacitor (fireproof and fire protected) (FIG. 2 (1)) and sensors (which can monitor temperature and size variation of the battery) (FIG. 2 (2)), which are fixed inside a casing (FIG. 2 (6)). This casing further consists a three-sided piezo electric container (FIG. 2 (4)), which contains a highly pressurized powdered or gaseous fire retardant. The fire retardant used can include carbon dioxide, powdered sodium bicarbonate, or any other such fire retardants appropriate for electrical fires.

The temperature and shape monitoring sensors take its power from the standalone button cell and does not require power from any outside source, and is therefore totally independent from the device or automobile battery [FIG. 2 (7)] being monitored.

There is also a tear-able film (FIG. 2 (5)), forming the fourth side of the three-sided piezoelectric container. The film which can tear under two-sided mechanical force is facing the battery in such a way that only the film separates the piezo electric container from the battery being monitored. Piezoelectric material being used in the present invention includes polymers such as polyvinylidene fluoride (PVDF), etc.

When there is rise in temperature or any change in temperature of the battery beyond the preconfigured benchmark limit set on the temperature sensor, or when there is any deformation or leaking from the battery noticed by the shape monitoring sensor, the sensors attached with casing trips the fuse (FIG. 2 (3)), connecting the piezoelectric container and the button cell. Thereafter, the electric charge from the button cell is received by the piezoelectric container.

This transfer of charge to the piezoelectric container changes the dimensions of the piezoelectric material in an inverse piezoelectric effect along the axis of the tear-able film, causing rupture of the film material due to generation of mechanical strain in response to the electric current. This rupture of the tear-able film material forming the fourth side of the piezoelectric container further results in the release of pressurized fire retardant from within the container into the battery area thereby engulfing the entire battery or group of batteries proactively and completely with a fire retardant eliminating any scope of combustion. This puts an end to any change in the battery that was sensed/detected by the sensors due to an increase in temperature or deformation of battery/batteries, preventing the explosion or any other kind of damage to the device or automobile.

In case a capacitor is used instead of a button cell, the capacitor draws charge from the device or automobile battery which the battery blast prevention system is monitoring up until the point the sensors trigger a shape change or critical temperature alert. When such an alert is detected, the capacitor seizes to draw power from the battery being monitored and uses the charge stored in it to send current to the piezo electric container for the purpose of tearing the film and releasing the fire retardant.

The battery blast prevention system has been designed in such a manner that it is universal, independent and isolated from the device which is taking power from the battery being protected, and therefore, problems associated with the device or with the battery management system will not affect the battery blast prevention system as disclosed by way of the present invention.

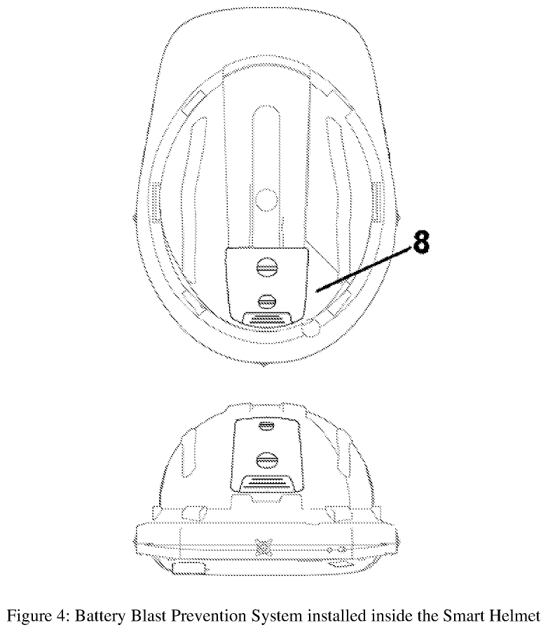

This system can be used in protecting the batteries that are used in the smart helmets, which are designed to provide multi-functions to the worker wearing it. Especially, in case of helmets, the protection from explosion of batteries must be ensured against exposure of the headgear to industrial gases, sparks, mechanical stress, etc. Therefore, the present invention helps the workmen to wear smart helmets without fearing from the explosion of the battery within the helmet. One such example has been demonstrated in FIG. 4 (8) of the drawings.

In another embodiment of the invention, the battery blast prevention system can be installed in a larger casing along with the battery (FIG. 2) or a group of batteries with a common power management system thereby ensuring that in case of a multi battery system, all batteries are engulfed with fire retardant even if a single battery triggers temperature or mechanical shape change alert. This helps prevent collateral damage risk of exposure of other batteries due to malfunctioning of a single battery.

These casing are replaceable with the new casing during the time the battery of the earlier casings gets recharged. Also, the system is reusable with new batteries in the same device till the time the piezo electric container is not activated.

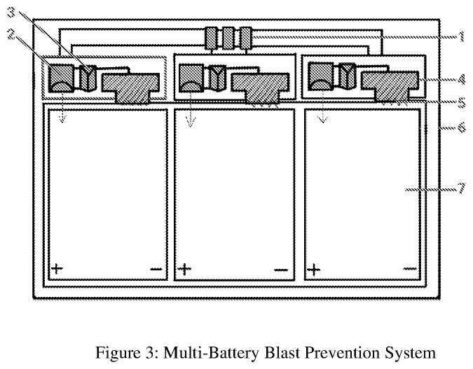

As highlighted earlier, the Battery Management System was not convenient to use in the case of multi-batteries and therefore, the maintenance of the same was cumbersome. There was a need to develop a technology that would provide safeguards to the multi-batteries from catching fire This battery blast prevention system can be easily employed to the scenario where multiple batteries are being used to operate a device. One of such embodiments has been shown by way of FIG. 3 of the drawings, where a separate battery blast prevention system has been provided for each battery. This system will assist the running of the device even if one of such batteries stop operating. In case of battery swaps, the system can be swapped along with the batteries ensuring similar protection even while the batteries have been swapped out and are being recharged as in case of industrial devices, electric vehicles and automobiles.

In another embodiment, a user can use single battery blast prevention system for multiple batteries depending on the requirement of the user.

The battery blast prevention system as disclosed will universally and proactively prevent single or multiple batteries of any chemistry, of any shape and of any size from catching fire, exploding or causing damage to the device itself or parts of device or adjoining batteries. The battery blast prevention system is an independent, modular, un-hackable, universally compliant and automated fail-safe kill switch for all kinds of battery and BMS malfunctions/faults across all battery types for electronic devices, electrical devices and electric vehicles. The system is interchangeable and can be swapped along with the batteries. Thus, making it the most effective fail-safe system to replace or add on to a battery management system.

I/We claim:

1. A system for battery blast prevention, the system comprising:
a) Independent cell (fireproof and fire protected) [FIG. 2 (1)];
Wherein the independent cell is noncombustible and standalone from the device or automobile battery being monitored;
b) Sensors and microcontrollers [FIG. 2 (2)] (for monitoring temperature and size variation of the battery [FIG. 2 (7)), which are fixed inside a casing [FIG. 2 (6)];
Wherein the temperature and shape monitoring sensors and microcontroller take their power from the independent cell without need of power from any outside source,
c) Three-sided piezo electric container [FIG. 2 (4)], containing a highly pressurized powdered or gaseous fire retardant for electrical fires;
d) Tear-able film [FIG. 2 (5)], forming fourth side of the three-sided piezo electric container;
Wherein if there is rise in temperature or any change in temperature of the battery beyond the pre-configured benchmark limit set on the temperature sensor or microcontroller or if there is any deformation or leaking from the battery that is noticed by the shape monitoring sensor or microcontroller, the sensors attached with casing trips the fuse (FIG. 2 (3)); connecting the piezoelectric container and the independent cell;
Wherein the electric charge from the cell is thereafter received by the piezoelectric container, which changes the dimensions of the piezoelectric material in an inverse piezoelectric effect along the axis of the tear-able film, causing rupture of the film material due to generation of mechanical strain in response to the electric current;
Wherein the rupture of the tear-able film results in the release of the pressurized fire retardant from the piezoelectric container and thereby engulfing the entire battery or group of batteries proactively and completely with a fire retardant eliminating the scope of combustion.

2. A battery blast prevention system as claimed in claim 1, wherein the capacitor is used instead of an independent cell.
Wherein the capacitor draws and stores charge from the device or automobile battery which the battery blast prevention system is monitoring up until the point the sensors trigger a shape change or critical temperature alert. When such an alert is detected, the capacitor seizes to draw power from the battery being monitored and uses the charge stored in it to send current to the piezo electric container for the purpose of tearing the film and releasing the fire retardant

3. A battery blast prevention system as claimed in claim 1, wherein the fire retardant can be selected from carbon dioxide, powdered sodium bicarbonate, or any other such fire retardants appropriate for safely extinguishing electrical fires.

4. A battery blast prevention system as claimed in claim 1, wherein the piezoelectric material includes polymers such as polyvinylidene fluoride (PVDF) among others.

5. A battery blast prevention system as claimed in claim 1, wherein the system can be applied to the smart helmets, designed to provide multi-functions to the user wearing it.

6. A battery blast prevention system as claimed in claim 1, wherein the system can be installed in a larger casing along with the battery [FIG. 3] or a group of batteries with a common independent cell or capacitor powering system, thereby ensuring that in case of a multi battery system, all batteries are engulfed with fire retardant even if a single battery triggers temperature or mechanical shape change alert, thereby preventing any domino effect.

7. A battery blast prevention system as claimed in claim 1, wherein a separate system can be provided for each battery or each battery cell in case multiple batteries are used to operate a device, thereby ensuring that the system assists in the running of the device even if one of such batteries stop operating because it has been incapacitated by the Battery Blast Prevention System.
